(19) United States
(12) Patent Application Publication
(10) Pub. No.: US 2009/0056509 A1
(43) Pub. Date: Mar. 5, 2009

(54) Pliers made of an in situ composite of bulk-solidifying amorphous alloy

(76) Inventor: Mark C. Anderson, Minnetonka, MN (US)

Correspondence Address: KAGAN BINDER, PLLC, SUITE 200, MAPLE ISLAND BUILDING, 221 MAIN STREET NORTH, STILLWATER, MN, 55082, US

(21) Appl. No.: 12/218,210

(22) Filed: Jul. 11, 2008

Related U.S. Application Data
(60) Provisional application No. 60/959,127, filed on Jul. 11, 2007.

(51) Int. Cl. B25B 7/00; C22C 45/10; B22D 21/00; B21K 5/18

(52) U.S. Cl. 81/342; 148/403; 148/538; 81/427.5; 76/119

(57) ABSTRACT

Pliers comprising a composite material comprising: individual regions of a ductile metal phase distributed in a substantially continuous amorphous metal alloy matrix are disclosed. Pliers comprising a first lever arm and a second lever arm that is complementary to the first lever arm, wherein the two arms are pivotally attached, and at least a portion of at least one of the two arms comprises the composite material are disclosed. A method of forming pliers is disclosed.

### PRIORITY

The present non-provisional patent application claims benefit from U.S. Provisional Patent Application having Ser. No. 60/959,127, filed on Jul. 11, 2007, by Anderson, and titled PLIERS MADE OF AN IN SITU COMPOSITE OF BULK-SOLIDIFYING AMORPHOUS ALLOY, wherein the entirety of said provisional patent application is incorporated herein by reference.

### FIELD OF THE INVENTION

The present invention relates generally to pliers, and more particularly relates to pliers made of an in situ composite of bulk-solidifying amorphous alloy.

### BACKGROUND OF THE INVENTION

Fishing requires tools for many different tasks. Probably the most commonly used tool are pliers. Pliers are used for many common fishing tasks, such as gripping and bending fish hooks, cutting hooks and wire, rigging tackle, removing fishhooks from fish, and adjusting fish lures and jigs. These tasks expose pliers to harsh conditions, such as water, dirt, and loads. The surfaces of pliers may wear out, have notches formed in them, may break, and/or may rust due to such use. Because of the conditions and use, the pliers have a limited useful life and are usually replaced often, or alternatively require significant maintenance, such as cleaning, sharpening of blades on the pliers and/or lubrication of a pivot point between arms of the pliers.

Pliers are commonly made of a high strength material such as conventional metal formulations. Some examples of materials used to make the arms include steel, stainless steel, aircraft grade aluminum, and titanium. Some of the commonly used materials are heavy. If the material is lightweight, it is generally quite expensive compared to the heavier materials.

The arms of pliers are generally cut from bulk or sheet metal by a computer numerical control (CNC) machine, for example. Therefore, any details on the pliers are generally cut into the pliers after a preliminary cut from bulk metal. Portions of the arms that may serve as jaws of the pliers may include details such as gripping portions for holding objects and/or blade portions used for cutting. Such portions are formed in the arms and finished after the arms are preliminarily cut from bulk metal.

There are different types of pliers that are used for different fishing tasks, in particular. There is what is deemed as sharp nose or needle nose type of pliers. There is also a pliers head referred to as a snub nose type.

The different types of pliers may have different details cut into the jaws and/or handles to accommodate different tasks. For example, the jaws may include teeth or notches for holding and/or cutting line or hooks. Such detail on the jaws, however, provides more opportunities or locations for breaking, dirt to collect, or rust to form on the jaws of pliers made of common materials.

Thus, there is a continuing need for new and improved pliers for use in fishing and other jobs, tasks and hobbies. In particular, a strong but ductile material that is lightweight is desirable for forming such pliers. Also, pliers that are easier to keep clean and in working condition, without significant maintenance, are desired. In addition, ease of manufacture and low cost are desired.

### SUMMARY OF THE INVENTION

In one aspect, the present invention relates to pliers made at least in part from a composite material, preferably a bulk-solidifying amorphous alloy, wherein the composite comprises individual regions of a ductile metal phase distributed in a substantially continuous amorphous metal alloy matrix. The composite material is preferably formed in situ by cooling or crystallization from a molten alloy, wherein the ductile metal phase precipitates first upon cooling and then the remaining molten alloy freezes into the amorphous metal alloy matrix. The ductile metal phase is preferably a primary crystalline phase of the main constituent element of the alloy and in dendritic and/or particle form. The result of the pliers being made of a material having separate phases is that the pliers have more resiliency than if the material had one phase alone.

In accordance with the invention, a pliers generally comprises a first lever arm and a second lever arm that is complementary to the first lever arm. The lever arms are generally pivotally attached at a pivot point in an intermediate portion of each arm, with a handle portion extending proximally from the intermediate portion of each arm and with a jaw portion extending distally on each arm from the intermediate portion. At least a portion, if not all, of any or all of the intermediate, jaw and handle portions of the pliers are made of the composite material described herein.

An exemplary composition for the composite material is, in atomic percent, from about 35 to about 90 percent total of zirconium plus titanium, from about 0 to about 30 percent beryllium, from about 2 to 25 percent niobium and from about 2 to about 35 percent total of copper plus nickel, plus incidental impurities, the total of the percentages being 100 atomic percent. An exemplary composition of the ductile metal phase is primarily Zr, Ti and Nb with substantially similar ratio in the overall alloy and with the total of other elements less than 10 atomic percent. An exemplary composition of an original composition of the ductile metal phase is from about 50 to 80 atomic percent zirconium, about 2 to about 20 atomic percent titanium, about 2 to about 10 atomic percent copper, about 1 to about 9 atomic percent nickel, about 0 to about 15 atomic percent beryllium, and about 1 to about 25 atomic percent niobium. Other metals that may be present in lieu of or in addition to niobium are selected from the group consisting of tantalum, tungsten, molybdenum, chromium and vanadium. These elements act to stabilize bcc symmetry crystal structure in Ti- and Zr-based alloys.

An exemplary composition for the amorphous metal alloy matrix is, in atomic percent, from about 35 to about 70 percent total of zirconium plus titanium, from about 0 to about 35 percent beryllium, and from about 5 to about 40 percent total of copper plus nickel, plus incidental impurities, the total of the percentages being 100 atomic percent. Other in situ composites of bulk-solidifying amorphous alloys and matrix of amorphous alloys may also be used.

The compositions and densities within a composite amorphous metal system may be varied in small increments but over a wide range, permitting weights of pliers to be arbitrarily determined by composition selection within a wide range. Pliers having different weights may be desired depending on different needs for the pliers.

There is provided in the practice of this invention, a method for forming pliers comprising a composite material comprising: individual regions of a ductile metal phase distributed in a substantially continuous amorphous metal alloy matrix. An alloy is heated above the melting point of the alloy, i.e., about its liquidus temperature. Upon cooling from the high temperature melt, the alloy chemically partitions; i.e., undergoes partial crystallization by nucleation and subsequent growth of a crystalline phase in the remaining liquid. The remaining liquid, after cooling below the glass transition temperature (considered a solidus) freezes to the amorphous or glassy state, producing a two-phase microstructure containing crystalline particles (or dendrites) in an amorphous metal matrix; i.e., a bulk metallic glass matrix.

The technique may be used to form a pliers. Such pliers would comprise individual regions of a ductile metal phase distributed in a substantially continuous amorphous metal alloy matrix. For example, the ductile metal phase may comprise crystalline metal dendrites having a primary length in the range of from 30 to 150 micrometers and secondary arms having a spacing between adjacent arms in the range of from 1 to 10 micrometers, more commonly in the order of about 6 to 8 micrometers.

Pliers made from a composite material comprising a ductile phase distributed in an amorphous phase have many advantages. As a consequence of the composite material, the pliers have a high yield strength, superior elastic limit, high corrosion resistance, high hardness, superior strength-to-weight ratio, high wear-resistance, and other characteristics associated with such materials. Pliers made of such material possess significantly greater strength, durability, impact resistance and “memory” than many conventional pliers.

Pliers made of such material are stronger and less likely to break, dull or deflect to an undue degree during use. The pliers thus retain their utility, while that of the conventional pliers would be lost.

Even if a load were severe enough to cause more significant deflection, the pliers of the present invention benefit from deformation “memory” (i.e., an ability to return to the original manufactured shape and configuration). In contrast, a conventional pliers will tend to permanently deform with an increased risk of lost utility.

Pliers made from the composite material described herein can be fabricated, if desired, using casting and molding processes. These can be one-step processes. Because of the superior strength of the composite material and the available methods of fabrication, pliers made from the composite material can be fabricated with finer and/or small structures. Small structures, such as teeth or blades on the jaws of the pliers are particularly important to the utility of pliers. With the arms being able to be cast or molded, details on the jaws portions may be formed upon molding or casting, and do not need to be made later. The reduction in the steps necessary to make the pliers may reduce the cost of the pliers. Therefore, it is more efficient to produce the pliers using such processes. In addition, a benefit of being able to cast or mold the fishing pliers allows for cut-outs to be formed in the handle portions of the arms, which enables the pliers to be made lighter and still be strong. Also, the pliers may be molded or cast to include gripping features, therefore not requiring separate covers or grips for the handle portions of the pliers that may slip off or wear out.

The pliers of the present invention are also corrosion resistant, even in salt water. This characteristic, too, helps the pliers have a longer service life than pliers made from a conventional metal formulation, and in particular while being used for fishing. Of particular importance, even fine features such as teeth on the blades of the pliers of the present invention can resist salt-water corrosion for long periods of time. In contrast, similar fine features of conventional pliers begin to corrode virtually immediately upon immersion in water and often show significant corrosion damage after only a few days.

The pliers of the present invention can be simply cleaned with soap and water, without the occurrence of corrosion. However, frequent cleaning of the pliers is not required because dirt does not easily adhere to the composite material from which the pliers are formed. Although the pliers are able to grip certain items in order to perform functions, such as cutting line, the material is lubricious enough to keep dirt from adhering to the surface.

Because the pliers of the present invention are less susceptible to damage, on average, the pliers stay in service (e.g., sharp) without need of repair or replacement for longer periods of time. Also, because anglers may spend less time maintaining such pliers (e.g., lubricating the pivot point, cleaning the pliers, and sharpening blades on the jaws), more time can be devoted to fishing, for example.

In situ composite of bulk-solidifying amorphous alloy may have a lower density than many conventional metal formulations. Pliers including such material, therefore, can be dramatically lighter than their conventional counterparts. As a result, anglers, for example, using the pliers are able to do so with less fatigue.

Pliers made from the composite material do not feel hot to the touch while in the sun or after being in close proximity to on-board machinery giving off heat. Therefore, gloves do not have to be worn to protect hands while handling the pliers. Gloves can be cumbersome or even dangerous while working on-board a fishing boat, for example, because they can get caught in machinery.

The pliers made of the composite material are non-magnetic. Therefore, the pliers may be placed in close proximity to electronics, and will not negatively affect the performance of the electronics. In particular on-board fishing boats, it is important that the electronics are kept in working order.

Therefore, the pliers of the present invention offer substantial improvements in strength, performance and length of life. The fishing pliers are also inexpensive to make and maintain.

One aspect of the present invention is pliers comprising the composite material wherein the individual regions of the ductile metal phase are distributed in the substantially continuous amorphous metal alloy matrix. The ductile metal phase is formed in situ in the matrix by crystallization from a molten alloy. The ductile metal phase may comprise an alloy having an original composition of from about 50 to 80 atomic percent zirconium, about 2 to about 20 atomic percent titanium, about 2 to about 10 atomic percent copper, about 1 to about 9 atomic percent nickel, about 0 to about 15 atomic percent beryllium, and about 1 to about 25 atomic percent niobium.

The regions of the ductile metal phase may be sufficiently spaced apart for inducing a uniform distribution of shear bands throughout a deformed volume of the composite material. The shear bands may involve at least four volume percent of the composite material before failure in strain and traverse both the amorphous metal alloy matrix and the ductile metal phase.

The ductile phase may be in the form of dendrites. The dendrites may have primary lengths of about 15 to 150 micrometers. The dendrites may further comprise secondary arms having widths of about 4 to 6 micrometers, and the secondary arms are spaced apart about 6 to 8 micrometers. The ductile metal phase may have an interface in chemical equilibrium with the amorphous metal alloy matrix. The ductile metal phase may comprise particles.

The regions of ductile metal phase may also be in the form of particles. The particles may be spaced apart from about 0.1 to about 20 micrometers. The particles may have a particle size from 0.1 to 15 micrometers. Spacing between adjacent particles may be from 0.1 to 20 micrometers. The particles may comprise from about 5 to 50 volume percent of the composite material. The particles may be sufficiently spaced apart for inducing a uniform distribution of shear bands traversing both the amorphous metal alloy matrix and the ductile metal phase and having a width of each shear band in the range of from 100 to 500 nanometers.

The ductile metal phase may comprise from 15 to 35 volume percent of the composite material. The composite material may be free of a third phase. The composite material may have a stress induced martensitic transformation. The amorphous metal alloy matrix may comprise from about 35 to about 70 atomic percent zirconium plus titanium, from about 0 to about 35 atomic percent beryllium, and from about 5 to about 40 atomic percent total of copper plus nickel. The composite material is corrosion resistant and wear-resistant.

Another aspect of the present invention is pliers comprising a first lever arm and a second lever arm that is complementary to the first lever arm, wherein the two arms are pivotally attached, and at least a portion of at least one of the two arms comprises a composite material comprising individual regions of a ductile metal phase distributed in a substantially continuous amorphous metal alloy matrix. The two arms may be pivotally attached by a pivot point in an intermediate portion of each arm, and each arm may include a handle portion extending proximally from the intermediate portion and a jaw portion that extends distally from the intermediate portion. The handle portions may include at least one cut-out.

A further aspect of the present invention is a method of forming pliers, comprising the steps of: providing a composite material comprising individual regions of a ductile metal phase distributed in a substantially continuous amorphous metal alloy matrix; and forming the composite into pliers. The ductile metal phase may be formed in situ in the amorphous metal alloy matrix by crystallization from a molten alloy. The forming step may be performed by a molding or a casting process.

Other features and advantages of the present invention will be apparent from the following more detailed description of the preferred embodiments, taken in conjunction with the accompanying drawings, which illustrate, by way of example, the principles of the invention. The scope of the invention is not, however, limited to the preferred embodiments.

### BRIEF DESCRIPTION OF THE DRAWINGS

The above mentioned and other advantages of the present invention, and the manner of attaining them, will become more apparent and the invention itself will be better understood by reference to the following description of the embodiments of the invention taken in conjunction with the accompanying drawings, wherein:

FIG. 1 is a side view of one embodiment of a pliers in accordance with the present invention in an open position;

FIG. 2 is a side view of a second embodiment of a pliers in accordance with the present invention in an open position;

FIG. 3 is a schematic binary phase diagram;

FIG. 4 is a pseudo-binary phase diagram of an exemplary alloy system for forming a composite by chemical partitioning;

FIG. 5 is a phase diagram of a Zr—Ti—Cu—Ni—Be alloy system; and

FIG. 6 is a compressive stress-strain curve for an in situ composite of bulk-solidifying amorphous alloy.

### DETAILED DESCRIPTION OF PRESENTLY PREFERRED EMBODIMENTS

The embodiments of the present invention described below are not intended to be exhaustive or to limit the invention to the precise forms disclosed in the following detailed description. Rather the embodiments are chosen and described so that others skilled in the art may appreciate and understand the principles and practices of the present invention.

The present invention is directed to pliers comprising a composite material comprising individual regions of a ductile metal phase distributed in a substantially continuous amorphous metal alloy matrix. Preferably, the ductile phase is formed in situ in the matrix by crystallization from a molten alloy. One example of such a composite material is a bulk-solidifying amorphous alloy, which is a ductile metal reinforced bulk metallic glass matrix composite.

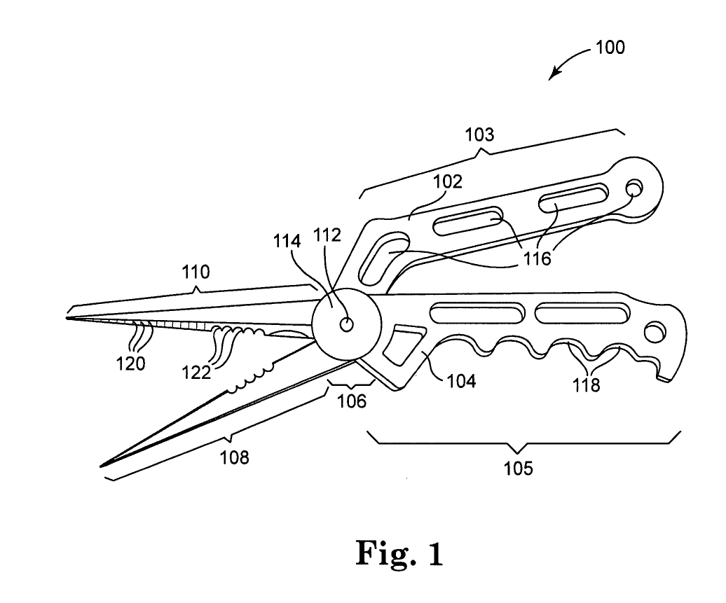

For purposes of illustration, FIG. 1 shows one embodiment of pliers 100, according to the present invention. As shown, the pliers 100 are needle nose pliers and include two lever arms 102, 104 that are complementary to one another. The first and second lever arms 102, 104 are pivotally attached at or joined together at corresponding intermediate or central portions, including a pivot point 106. Extending from the pivot point 106, toward a proximal end of each arm 102, 104, are a pair of oppositely disposed handle portions 103, 105. At the end of each arm 102, 104, opposite the handle portions 103, 105, are jaw portions 108, 110. The first and second lever arms 102, 104 are joined together at a pivot point 106 that, as shown, comprises a pivot pin 112 that is formed as part of the first lever arm 102 and a cylindrical coupling hole 114 formed in the second lever arm 104, which is shaped to surround the pivot pin 112. The pivot point 106 shown is one exemplary means of pivotally attaching the two lever arms 102, 104. The purpose of the pivot point 106 is to allow the two lever arms 102, 104 to be pivotally attached such that the jaw portions 108, 110 may be in a closed position or an open position with respect to one another, and may pivot between such positions to cut, bend, hold, or otherwise perform some desired function. Other pivot points or pivotal attachment means for the two lever arms 102, 104, besides those shown, are also contemplated by the present invention.

The pliers 100 as shown include cut-outs 116. Such cut-outs 116 are possible due to the composite material disclosed herein that is used to make the pliers 100 and due to the possible methods of making the pliers 100, which include molding and casting. The cut-outs allow the pliers 100 to be lighter, but while still retaining their strength. A plurality of cut-outs 116 in the lever arms 102, 104 is contemplated by the present invention. The cut-outs 116 may be different in number, shape, and placement, as compared to those shown, however.

The cut-outs 116 are preferably located in the handle portions 103, 105 of the pliers 100. Also preferably molded or cast into at least one of the handle portions 103, 105 (shown on 105 in FIG. 1) are finger indentations 118, which aid in holding or gripping the pliers 100 during use.

The jaw portions 108, 110 of the pliers 100 are shown to include details. For example, hash marks 120 are shown, which aid the jaws in gripping certain items. Notches 122 of different sizes are also shown, and are for the purpose of cutting, bending or grasping different items, such as fishing line or hooks. The notches 122 may include blades or other cutting surfaces. Other such details on the jaw portions 108, 110 that are not shown or disclosed herein are also contemplated by the present invention. The purpose of such detail is to enable the pliers to perform a desired task.

The pliers 100 are formed at least in part of composite material as discussed in detail below. Preferably, the composite material is an in situ composite of bulk-solidifying amorphous alloy.

Although not shown in FIG. 1, such pliers may include covers or grips for covering the handle portions 103, 105 of the two lever arms 102, 104. The grips may be made of an anti-slip material, such as synthetic rubber, natural rubber or pliable plastic materials. Other suitable materials for the grips are also contemplated, and are not limited to those listed herein. However, grips are not necessary to use the pliers of the present invention since gripping features may be easily cast or molded into the lever arms.

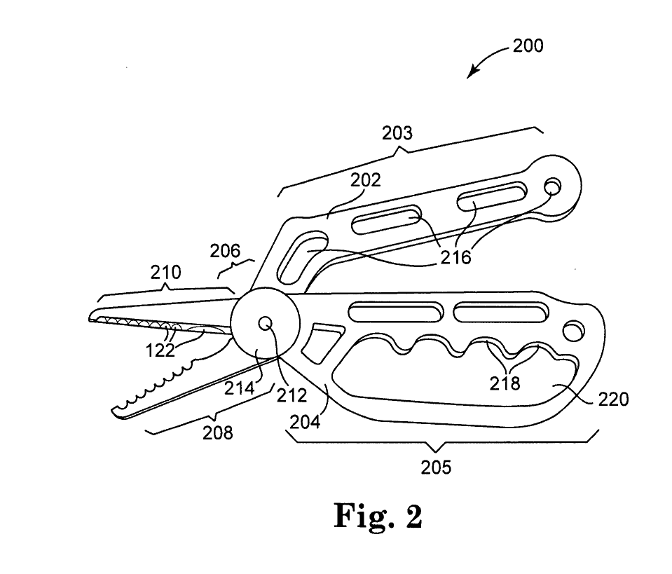

FIG. 1 shows a sharp nose or needle nose pliers. Referring now to FIG. 2, another embodiment of the invention is shown, and is known as a pair of snub nose pliers 200. Similar to the pliers 100 in FIG. 1, pliers 200 include two lever arms 202, 204 that are complementary to one another. The first and second lever arms 202, 204 include corresponding intermediate or central portions or a pivot point 206. Extending proximally from the pivot point 206 are handle portions 203, 205. Opposite the handle portions 203, 205 are jaw portions 208, 210. The first and second lever arms 202, 204 are joined together at the pivot point 206 that, as shown, comprises a pivot pin 212 that is formed as part of the first lever arm 202 and a cylindrical coupling hole 214 formed in the second lever arm 204, which is shaped to surround the pivot pin 212. The pivot point 206 shown is also only one exemplary means of pivotally attaching the two lever arms 202, 204, and other pivoting means are also contemplated.

The pliers 200 may also preferably include cut-outs 216, as described above with regard to pliers 100. Also, at least one of the handle portions 203, 205 (205 in FIG. 2) may include finger indentations 218 that are cast or molded into the handle portion, which aid in holding the pliers 200. The pliers 200 shown also include an opening 220 that allows the pliers 200 to surround a user's hand as it grips or holds the pliers 200.

The pliers 200 may also include covers or grips that cover the handle portions 203, 205, as described above with regard to the pliers 100. In addition, the pliers 200 are formed at least in part of a composite material as discussed in detail below. Preferably the composite material is in situ composite of bulk-solidifying amorphous alloy.

The jaw portions 208, 210 of pliers 200 also include details. The pliers 200 are shown to include notches 122 of different sizes and shapes. Other details (not shown) on the jaw portions 208, 210 are also contemplated by the present invention.

The pliers shown in FIG. 1 and FIG. 2 are provided for exemplary purposes. Pliers including other components and/or different features are also contemplated by the present invention. The pliers may be used for fishing, as well as other tasks, jobs and hobbies.

The composite material used in the practice of the invention may include a bulk-solidifying amorphous metal alloy. Bulk-solidifying amorphous metal alloys may be cooled from the melt at relatively low cooling rates, on the order of 500° C. per second or less, yet retain an amorphous structure. Such metals do not experience a liquid/solid crystallization transformation upon cooling, as with conventional metals. Instead, the highly fluid, non-crystalline form of the metal found at high temperatures becomes more viscous as the temperature is reduced, eventually taking on the outward physical appearance and characteristics of a conventional solid. Even though there is no liquid/solid crystallization transformation for such a metal, an effective “freezing temperature”, Tg (often referred to as the glass transition temperature), may be defined as the temperature below which the viscosity of the cooled liquid rises above 10¹³ poise. At temperatures below Tg, the material is, for all practical purposes, a solid. An effective “fluid temperature”, Tf, may be defined as the temperature above which the viscosity falls below 10² poise. At temperatures above Tf, the material is for all practical purposes a liquid. At temperatures between Tf and Tg, the viscosity of the bulk-solidifying amorphous metal changes slowly and smoothly with temperature. For the zirconium-titanium-nickel-copper-beryllium alloy of the preferred embodiment, Tg is about 350-400° C. and Tf is about 700-800° C.

This ability to retain an amorphous structure even with a relatively slow cooling rate is to be contrasted with the behavior of other types of amorphous metals that require cooling rates of at least about 10⁴-10⁶° C. per second from the melt to retain the amorphous structure upon cooling. Such metals may only be fabricated in amorphous form as thin ribbons or particles. Such a metal has limited usefulness because it cannot be prepared in the thicker sections required for typical articles of the type prepared by more conventional casting techniques, and it certainly cannot be used to prepare three-dimensional articles such as pliers.

An exemplary type of bulk-solidifying amorphous alloy has a composition of about that of a deep eutectic composition. Such a deep eutectic composition has a relatively low melting point and a steep liquidus. The composition of the bulk-solidifying amorphous alloy should therefore preferably be selected such that the liquidus temperature of the amorphous alloy is no more than about 50-75° C. higher than the eutectic temperature, so as not to lose the advantages of the low eutectic melting point.

An exemplary type of bulk-solidifying amorphous alloy family has a composition near a eutectic composition, such as a deep eutectic composition with a eutectic temperature on the order of 660° C. This material has a composition, in atomic percent, of from about 35 to about 90 percent total of zirconium plus titanium, from about 0 to about 30 percent beryllium, from about 2 to 25 percent niobium and from about 2 to about 35 percent total of copper plus nickel, plus incidental impurities, the total of the percentages being 100 atomic percent. A substantial amount of hafnium may be substituted for some of the zirconium and titanium; aluminum may be substituted for the beryllium in an amount up to about half of the beryllium present; and up to a few percent of iron, chromium, molybdenum, or cobalt may be substituted for some of the copper and nickel. This bulk-solidifying alloy is known and is described in U.S. Pat. No. 5,288,344.

Another such metal alloy family material has a composition, in atomic percent, of from about 25 to about 85 percent total of zirconium and hafnium, from about 5 to about 35 percent aluminum, and from about 5 to about 70 percent total of nickel, copper, iron, cobalt, and manganese, plus incidental impurities, the total of the percentages being 100 atomic percent. An exemplary metal alloy of this group has a composition, in atomic percent, of about 60 percent zirconium about 15 percent aluminum, and about 25 percent nickel.

The bulk-solidifying amorphous alloys have excellent corrosion resistance. They have as-cast surfaces that are very smooth, when cast against a smooth surface, making it attractive in appearance. The bulk-solidifying amorphous alloys may be readily cast as pliers using a number of techniques, most preferably permanent mold casting, permitting fabrication of the components at reasonable cost.

The composites including such bulk-solidifying alloys used in the pliers preferably have an exceedingly high strength-to-density ratio. This property of the material may be characterized as a strength-to-density ratio of at least about 1×10⁶ inches, and preferably greater than about 1.2×10⁶ inches.

The density properties of bulk-solidifying amorphous alloys offer two important advantages to the design of pliers having a composite including such a material, which is not available with other candidate materials. The first is the absolute value of the density range of the materials, and the second is the ability to vary the density over a wide range while maintaining other pertinent mechanical and physical properties within acceptable ranges. As to the absolute value of the density range, the densities of the preferred bulk-solidifying amorphous alloys are from about 5.0 grams per cc to about 7.0 grams per cc. The densities of conventional materials are relatively constant and cannot be readily varied. There is a large gap in density between copper-beryllium and steel, at the upper end, and titanium. The present alloys lie in this gap region of density. Their use permits, for example, a pliers to have the same size as a conventional pliers, but to have a lower weight.

The second significant virtue of including amorphous alloys in the material used to manufacture pliers is that their densities may be selectively varied over a moderately wide range of values. For example, within the broad composition range of the preferred alloy (having a composition, in atomic percent, of from about 45 to about 67 percent total of zirconium plus titanium, from about 0 to about 35 percent beryllium, and from about 10 to about 38 percent total of copper plus nickel, plus incidental impurities, the total of the percentages being 100 atomic percent), the densities may be varied from about 5.0 grams per cc to about 7 grams per cc by changing the compositions while staying in the permitted range that results in a bulk-solidifying amorphous alloy.

Although the use of bulk solidifying amorphous alloys on the construction of pliers provides substantial advantages, using homogeneous bulk-solidifying amorphous alloys (or bulk metallic glasses) has still some shortcomings. First, these materials generally fail as the result of the formation of localized shear bands with minimal plastic deformation beyond elastic strain limit, which leads to catastrophic failure. Secondly, their impact resistance is also limited, which leads to unstable crack growth and propagation upon impacts exceeding design limits. As such their use becomes limited especially considering the durability and unpredictable impact loads during use.

Accordingly, one can improve items made from such bulk-solidifying amorphous alloys by using a different class of material, which is in situ composites of bulk-solidifying amorphous alloy (or ductile metal reinforced bulk metallic glass matrix composite). Such composite material preserves desirable properties such as high elastic strain limit to 2% and high yield strength up to 1.6 GPa, while providing tensile ductility up to 10% and impact toughness several times of homogenous bulk-solidifying amorphous alloy. Furthermore, the in situ composite material provides a lower modulus of elasticity, in large part due to lower modulus of dendritic phase (which is extended solid solution of primary phase of the main constituent element).

A unique characteristic of an in situ composite of bulk-solidifying amorphous alloy, such as that commercially available from Liquidmetal Technologies of Lake Forest, Calif., U.S.A., is the availability of superior mechanical properties in as-cast form. This characteristic allows pliers of the present invention to be easily fabricated using casting and/or other molding techniques.

The following describes the details and preparation of methods of in situ composites of bulk-solidifying amorphous alloy. The material exhibits both improved toughness and a large plastic strain to failure. It should be understood that the pliers of the present invention can be made of these composite materials.

The remarkable glass-forming ability of bulk metallic glasses at low cooling rates (e.g., less than about 10³ K/sec) allows for the preparation of ductile metal reinforced composites with a bulk metallic glass matrix via in situ processing; i.e., chemical partitioning. The incorporation of a ductile metal phase into a metallic glass matrix yields a constraint that allows for the generation of multiple shear bands in the metallic glass matrix. This stabilizes crack growth in the matrix and extends the amount of strain to failure of the composite. Specifically, by control of chemical composition and processing conditions, a stable two-phase composite (ductile crystalline metal in a bulk metallic glass matrix) is obtained on cooling from the liquid state.

In order to form a composite amorphous metal object by chemical partitioning, one starts with a composition that may not, by itself, form an amorphous metal upon cooling from the liquid phase at reasonable cooling rates. Instead, the composition includes additional elements or a surplus of some of the components of an alloy that would form a glassy state on cooling from the liquid state.

A particularly attractive bulk glass-forming alloy system is described in U.S. Pat. No. 5,288,344. For example, to form a composite having a crystalline reinforcing phase and an amorphous matrix, one may start with an alloy in a bulk glass-forming zirconium-titanium-copper-nickel-beryllium system with added niobium. Such a composition is melted so as to be homogeneous. The molten alloy is then cooled to a temperature range between the liquidus and solidus for the composition. This causes chemical partitioning of the composition into solid crystalline ductile metal dendrites and a liquid phase, with different compositions. The liquid phase becomes depleted of the metals crystallizing into the crystalline phase and the composition shifts to one that forms a bulk metallic glass at low cooling rate. Further cooling of the remaining liquid results in formation of an amorphous matrix around the crystalline phase.

Alloys suitable for practice of this invention have a phase diagram with both a liquidus and a solidus that each include at least one portion that is vertical or sloping, i.e., that is not at a constant temperature.

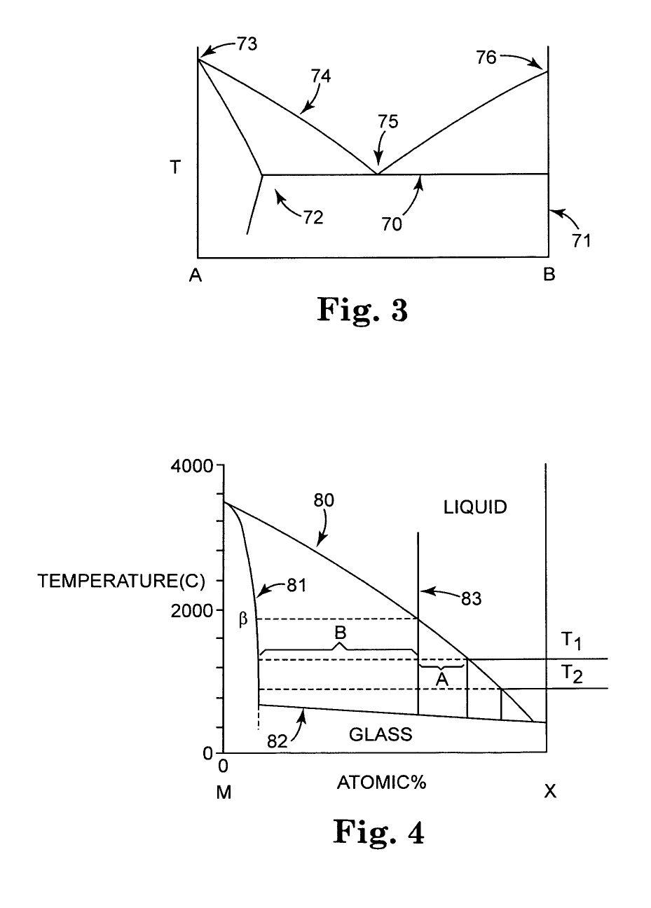

Consider, for example, a binary alloy, AB, having a phase diagram with a eutectic and solid solubility of one metal A in the other metal B as shown in FIG. 3. In such an alloy system the phase diagram has a horizontal or constant temperature solidus line 70 at the eutectic temperature extending from B 71 to a point 72 where B is in equilibrium with a solid solution of B in A. The solidus line 70 then slopes upwardly from the equilibrium point 72 to the melting point of A 73. The liquidus line 74 in the phase diagram extends from the melting point of A 73 to the eutectic composition 75 on the horizontal solidus 70 and from there to the melting point of B 76. Thus, the solidus 70 has a portion that is not at a constant temperature (between the melting point of A 73 and the equilibrium point 72). The vertical line from the melting point of B to the eutectic temperature could also be considered a solidus line where there is no solid solubility of A in B. Likewise, the liquidus 74 has sloping lines that are not at constant temperature. In a ternary alloy phase diagram there are solidus and liquidus surfaces instead of lines.

When referring to the solidus herein, it should be understood that this may not be entirely the same as the solidus in a conventional crystalline metal phase diagram, for example. In usage herein, the solidus refers in part to a line (or surface) defining the boundary between liquid metal and a solid phase. This usage is appropriate when referring to the boundary between the melt and a solid crystalline phase precipitated for forming the phase embedded in the matrix. For the glass-forming remainder of the melt the “solidus” is typically not at a well-defined temperature, but is where the viscosity of the alloy becomes sufficiently high that the alloy is considered to be rigid or solid. Knowing an exact temperature is not important.

Before considering alloy selection, we discuss the partitioning method in a pseudo-binary alloy system. FIG. 4 is a phase diagram for alloys of M and X where X is a good glass-forming composition, i.e., a composition that forms an amorphous metal at reasonable cooling rates. Compositions range from 100% M at the left margin to 100% of the alloy X at the right margin. An upper slightly curved line 80 is a liquidus for M in the alloy and a steeply curving line 81 near the left margin is a solidus for M with some solid solution of components of X in a body centered cubic (bcc) M alloy. A horizontal or near horizontal line 82 below the liquidus is, in effect, a solidus for an amorphous alloy. A vertical line 83 in mid-diagram is an arbitrary alloy where there is an excess of M above a composition that is a good bulk glass-forming alloy.

As one cools the alloy from the liquid, the temperature encounters the liquidus 80. A precipitation of bcc M (with some of the X components, principally titanium and/or zirconium, in solid solution) commences with a composition where a horizontal line from the liquidus encounters the solidus 81. With further cooling, there is dendritic growth of M crystals, depleting the liquid composition of M, so that the melt composition follows along the sloping liquidus line 80. Thus, there is a partitioning of the composition to a solid crystalline bcc, M-rich phase and a liquid composition depleted in M.

At an arbitrary processing temperature T₁ the proportion of solid M alloy corresponds to the distance A and the proportion of liquid remaining corresponds to the distance B in FIG. 4. In other words, about ¼ of the composition is solid dendrites and the other ¾ is liquid. At equilibrium at a second processing temperature T₂ somewhat lower than T₁, there is about ⅓ solid crystalline phase and ⅔ liquid phase.

If one cools the exemplary alloy to the first or higher processing temperature T₁ and holds at that temperature until equilibrium is reached, and then rapidly quenches the alloy, a composite is achieved having about ¼ particles of bcc alloy distributed in a bulk metallic glass matrix having a composition corresponding to the liquidus at T₁. One can vary the proportion of crystalline and amorphous phases by holding the alloy at a selected temperature above the solidus, such as for example, at T₂ to obtain a higher proportion of ductile metallic particles.

Instead of cooling and holding at a temperature to reach equilibrium as represented by the phase diagram, one is more likely to cool from the melt continuously to the solid state. The morphology, proportion, size and spacing of ductile metal dendrites in the amorphous metal matrix is influenced by the cooling rate. Generally speaking, a faster cooling rate provides less time for nucleation and growth of crystalline dendrites, so they are smaller and more widely spaced than for slower cooling rates. The orientation of the dendrites is influenced by the local temperature gradient present during solidification.

For example, to form a composite with good mechanical properties, and having a crystalline reinforcing phase embedded in an amorphous matrix, one may start with compositions based on bulk metallic glass-forming compositions in the Zr—Ti—M—Cu—Ni—Be system, where M is niobium. Alloy selection can be exemplified by reference to FIG. 4 which is a section of a pseudo-ternary phase diagram with apexes of titanium, zirconium and X, where X is Be₉Cu₅Ni₄.

There are at least two strategies for designing a useful composite of crystalline metal particles distributed in an amorphous matrix in this alloy system. Strategy 1 is based on systematic manipulations of the chemical composition of bulk metallic glass forming compositions in the Zr—Ti—Cu—Ni—Be system. Strategy 2 is based on the preparation of chemical compositions which comprise the mixture of additional pure metal or metal alloys with a good bulk metallic glass-forming composition in the Zr—Ti—Cu—Ni—Be system.

Strategy 1: Systematic Manipulation of Bulk Metallic Glass-Forming Compositions.

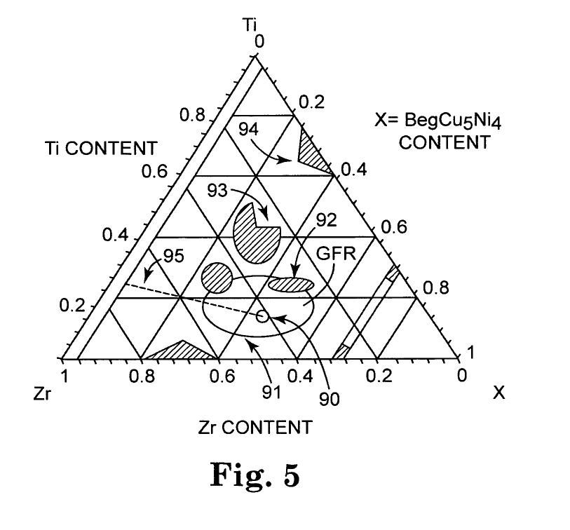

An excellent bulk metallic glass-forming composition has been developed with the following chemical composition: (Zr₇₅Ti₂₅)₅₅X₄₅=Zr_{41.2}Ti_{13.8}Cu_{12.5}Ni₁₀Be_{22.5} expressed in atomic percent, and herein labeled as alloy V1. This alloy composition has a proportion of Zr to Ti of 75:25. It is represented on the ternary diagram at the small circle 90 in the large oval 91 (FIG. 5).

Around the alloy composition V1 lies a large region of chemical compositions which form a bulk metallic glass object (an object having all of its dimensions greater than one millimeter) on cooling from the liquid state at reasonable rates. This bulk glass-forming region (GFR) is defined by the oval labeled 91 and GFR in FIG. 5. When cooled from the liquid state, chemical compositions that lie within this region are fully amorphous when cooled below the glass transition temperature.

The pseudo-ternary diagram shows a number of competing crystalline or quasi-crystalline phases which limit the bulk metallic glass-forming ability. Within the GFR these competing crystalline phases are destabilized, and hence do not prevent the vitrification of the liquid on cooling from the molten state. However, for compositions outside the GFR, on cooling from the high temperature liquid state the molten liquid chemically partitions. If the composition is alloyed properly, it forms a good composite engineering material with a ductile crystalline metal phase in an amorphous matrix. There are compositions outside GFR where alloying is inappropriate and the partitioned composite may have a mixture of brittle crystalline phases embedded in an amorphous matrix. The presence of these brittle crystalline phases seriously degrades the mechanical properties of the composite material formed.

For example, toward the upper right of the larger GFR oval, there is a smaller oval 92 partially overlapping the edge of the larger oval 91, and in this region a brittle Cu₂ZrTi phase may form on cooling the liquid alloy. This is an embrittling phenomenon and such alloys are not suitable for practice of this invention. The regions indicated on this pseudo-ternary diagram are approximate and schematic for illustrating practice of this invention.

Above the left part of large GFR oval 91 as illustrated in FIG. 5 there is a smaller circle 90 representing a region where a quasi-crystalline phase forms, another embrittling phenomenon. An upper partial oval 93 represents another region where a NiTiZr Laves phase forms. A small triangular region 94 along the Zr—X margin represents formation of intermetallic TiZrCu₂ and/or Ti₂Cu phases. Small regions near 70% X are compositions where a ZrBe₂ intermetallic or a TiBe₂ Laves phase forms. Along the Zr—Ti margin a mixture of and Zr or Zr—Ti alloy may be present.

To form a composite with good mechanical properties, a ductile second phase is formed in situ. Thus, the brittle second phases identified in the pseudo-ternary diagram are to be avoided. This leaves a generally triangular region toward the upper left from the Zr₄₂Ti₁₄X₄₄ circle where another metal M may be substituted for some of the zirconium and/or titanium to provide a composite with desirable properties. This is reviewed for a substitution of niobium for some of the titanium.

A dashed line 95 is drawn on FIG. 5 toward the 25% titanium composition on the Zr—Ti margin. In the series of compositions along the dashed line, (Zr₁₀₀₋ₓTi_{x-z}M_{z})_{100-y}((Ni₄₅Cu₅₅))₅₀Be₅₀)_{y} where M=Nb and x=25, increasing z means decreasing the amount of titanium from the original proportion of 75:25. In the portion of the dashed line 95 within the larger oval 91, the compositions are good bulk glass-forming alloys. Once outside the oval 91, ductile dendrites rich in zirconium form in a composite with an amorphous matrix. These ductile dendrites are formed by chemical partitioning over a wide range of z and y values.

For example, when z=3 and y=25, there is formation of phase. It has been shown that phase is formed when z=13.3, extending up to z=20 with y values surrounding 25. Excellent mechanical properties have been found for compositions in the range of z=5 to z=10, with a premier composition where z=about 6.66 along this 75:25 line when M is niobium.

It should be noted that one should not extend along the 75:25 dashed line 95 to less than about 5% beryllium, i.e., where y is less than 10. Below that there is little amorphous phase left and the alloy is mostly dendrites without the desirable properties of the composite.

Consider an alloy series of the form (Zr₁₀₀₁₀₀₋ₓTi_{x-z}M_{z})_{100-y}X_{y} where M is an element that stabilizes the crystalline phase in Ti- or Zr-based alloys and X is defined as before. To form an in situ prepared bulk metallic glass matrix composite material with good mechanical properties it is important that the secondary crystalline phase, preferentially nucleated on cooling from the high temperature liquid, be a ductile second phase. An example of an in situ prepared bulk metallic glass matrix composite which has exhibited outstanding mechanical properties has the nominal composition (Zr₇₅Ti_{18.34}Nb_{6.66})₇₅X₂₅; i.e., an alloy with M=Nb, z=6.66, x=18.34 and y=25. This is along the dashed line 95 of alloys in FIG. 5.

Peaks on an x-ray diffraction pattern for this composition show that the secondary phase present has a bcc or phase crystalline symmetry, and that the x-ray pattern peaks are due to the phase only. A Nelson-Riley extrapolation yields a phase lattice parameter a=3.496 Angstroms. Thus, upon cooling from the high temperature melt, the alloy undergoes partial crystallization by nucleation and subsequent dendritic growth of the ductile crystalline metal phase in the remaining liquid. The remaining liquid subsequently freezes to the glassy state producing a two-phase microstructure containing phase dendrites in an amorphous matrix.

SEM electron microprobe analysis gives the average composition for the phase dendrites to be Zr₇₁Ti_{l6.3}Nb₁₀Cu_{1.8}Ni_{0.9}. Under the assumption that all of the beryllium in the alloy is partitioned into the matrix, we estimate that the average composition of the amorphous matrix (dark phase) is Zr₄₇Ti_{12.9}Nb_{2.8}Cu₁₁Ni_{9.6}Be_{16.7}. Microprobe analysis also shows that within experimental error (about ±1 at. %), the compositions within the two phases do not vary. This implies complete solute redistribution and the establishment of chemical equilibrium within and between the phases.

Differential scanning calorimetry analysis of the heat of crystallization of the remaining amorphous matrix compared with that of the fully amorphous sample gives a direct estimate of the molar fractions (and volume fractions) of the two phases. This gives an estimated fraction of about 25% phase by volume and about 75% amorphous phase. Direct estimates based on area analysis of the SEM image agree well with this estimate. The SEM image shows the fully developed dendritic structure of the phase. The dendritic structures are characterized by primary dendrite axes with lengths of 50-150 micrometers and radius of about 1.5-2 micrometers. Regular patterns of secondary dendrite arms with spacing of about 6-7 micrometers are observed, having radii somewhat smaller than the primary axis. The dendrite “trees” have a very uniform and regular structure. The primary axes show some evidence of texturing over the sample as expected since dendritic growth tends to occur in the direction of the local temperature gradient during solidification.

The relative volume proportion of the phase present in the in situ composite can be varied greatly by control of the chemical composition and the processing conditions. For example, by varying the y value in the alloy series along the dashed line in FIG. 5, (Zr₇₅Ti_{18.34}Nb_{6.66})_{100-y}X_{y}, with M=Nb; i.e., by varying the relative proportion of the early- and late-transition metal constituents; the resultant microstructure and mechanical behavior exhibited on mechanical loading changes dramatically. In situ composites in the Zr—Ti—M—Cu—Ni—Be system have been prepared for alloy series other than the series along the dashed line. These additional alloy series sweep out a region of the quinary composition phase space shown in FIG. 5. The region sweeps in a clockwise direction from a line (not shown) from the V1 alloy composition to the Zr apex of the pseudo-ternary diagram through the dashed line, and extending through to a line (not shown) from the V1 alloy to the Ti apex of the pseudo-ternary diagram, but excluding those regions where a brittle crystalline, quasi-crystalline or Laves phase is stable.

Strategy 2: The Preparation of In Situ Composites by the Mixture of Pure Metal or Metal Alloys with Bulk Metallic Glass-Forming Compositions.

As an additional example of the design of in situ composites by chemical partitioning, we discuss the following series of materials. These alloys are prepared by rule of mixture combinations of a metal or metal alloy with a good bulk metallic glass (BMG) forming composition. The formula for such a mixture is given by BMG(100-x)+M(x) or BMG(100−x)+Nb(x), where M=Nb. Preferably, in situ composite alloys of this form are prepared by first melting the metal or metallic alloy with the early transition metal constituents of the BMG composition. Thus, pure Nb metal is mixed via arc melting with the Zr and Ti of the V1 alloy. This mixture is then arc melted with the remaining constituents; i.e., Cu, Ni, and Be, of the V1 BMG alloy. This molten mixture, upon cooling from the high temperature melt, undergoes partial crystallization by nucleation and subsequent dendritic growth of nearly pure Nb dendrites, with phase symmetry, in the remaining liquid. The remaining liquid subsequently freezes to the glassy state producing a two-phase microstructure containing Nb rich beta phase dendrites in an amorphous matrix.

If one starts with an alloy composition-with an excess of approximately 25 atomic % niobium above a preferred composition (Zr_{41.2}Ti_{13.8}Cu_{12.4}Ni_{10.1}Be_{22.5}) for forming a bulk metallic glass, ductile niobium alloy crystals are formed in an amorphous matrix upon cooling a melt through the region between the liquidus and solidus. The composition of the dendrites is about 82% (atomic %) niobium, about 8% titanium, about 8.5% zirconium, and about 1.5% copper plus nickel. This is the composition found when the proportion of dendrites is about ¼ bcc phase and ¾ amorphous matrix. Similar behaviors are observed when tantalum is the additional metal added to what would otherwise be a V1 alloy. Besides niobium and tantalum, suitable additional metals which may be in the composition for in situ formation of a composite may include molybdenum, chromium, tungsten and vanadium.

The proportion of ductile bcc-forming elements in the composition can vary widely. Composites of crystalline bcc alloy particles distributed in a nominally V1 matrix have been prepared with about 75% V1 plus 25% Nb, 67% V1 plus 33% Nb (all percentages being atomic). The dendritic particles of bcc alloy form by chemical partitioning from the melt, leaving a good glass-forming alloy for forming a bulk metallic glass matrix.

Partitioning may be used to obtain a small proportion of dendrites in a large proportion of amorphous matrix all the way to a large proportion of dendrites in a small proportion of amorphous matrix. The proportions are readily obtained by varying the amount of metal added to stabilize a crystalline phase. By adding a large proportion of niobium, for example, and reducing the sum of other elements that make a good bulk metallic glass-forming alloy, a large proportion of crystalline particles can be formed in a glassy matrix.

It appears to be important to provide a two-phase composite and avoid formation of a third phase. It is clearly important to avoid formation of a third brittle phase, such as an intermetallic compound, Laves phase or quasi-crystalline phase, since such brittle phases significantly degrade the mechanical properties of the composite.

It may be feasible to form a good composite as described herein, with a third phase or brittle phase having a particle size significantly less than 0.1 micrometers. Such small particles may have minimal effect on formation of shear bands and little effect on mechanical properties.

In the niobium enriched Zr—Ti—Cu—Ni—Be system, the microstructure resulting from dendrite formation from a melt comprises a stable crystalline Zr—Ti—Nb alloy, with beta phase (bcc) structure, in a Zr—Ti—Nb—Cu—Ni—Be amorphous metal matrix. These ductile crystalline metal particles distributed in the amorphous metal matrix impose intrinsic geometrical constraints on the matrix that leads to the generation of multiple shear bands under mechanical loading.

Sub-standard size Charpy specimens were prepared from a new in situ-formed composite material having a total nominal alloy composition of Zr_{56.25}Nb₅Ti_{l3.76}CU_{6.875}Ni_{5.625}Be_{12.5}. These have demonstrated Charpy impact toughness numbers that are 250% greater than that of the bulk metallic glass matrix alone; 15 ft-lb. vs. 6 ft-lb. Bend tests have shown large plastic strain to failure values of about 4%. The multiple shear band structures generated during these bend tests have a periodicity of spacing equal to about 8 micrometers, and this periodicity is determined by the phase dendrite morphology and spacing. In some cast plates with a faster cooling rate, plastic strain to failure in bending has been found to be about 25%. Samples have been found that will sustain a 180° bend.

In a specimen after straining, shear bands traverse both the amorphous metal matrix phase and the ductile metal dendrite phase. The directions of the shear bands differ slightly in the two phases due to different mechanical properties and probably because of crystal orientation in the dendritic phase.

Shear band patterns as described occur over a wide range of strain rates. A specimen showing shear bands crossing the matrix and dendrites was tested under quasi-static loading with strain rates of about 10⁻⁴ to 10⁻³ per second. Dramatically improved Charpy impact toughness values show that this mechanism is operating at strain rates of 10³ per second, or higher.

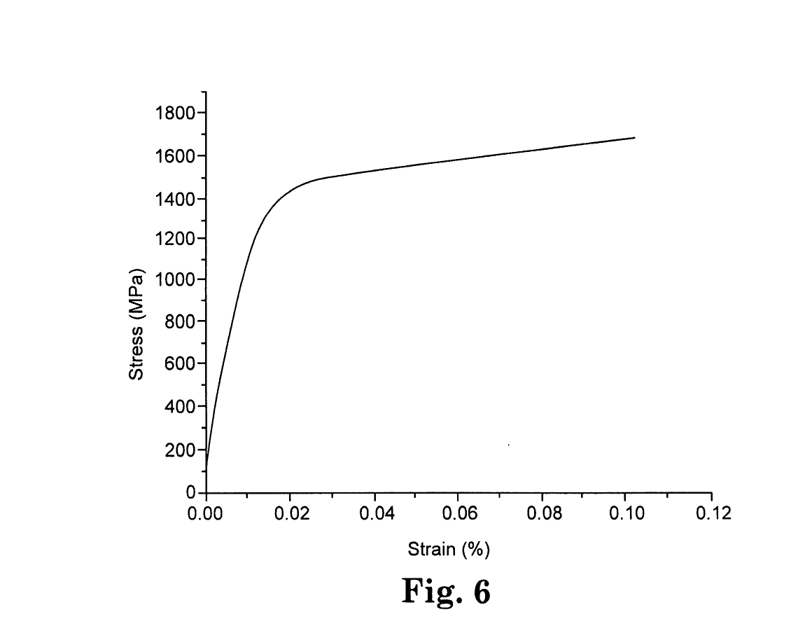

Specimens tested under compressive loading exhibit large plastic strains to failure on the order of 8%. An exemplary compressive stress-strain curve as shown in FIG. 6, exhibits an elastic-perfectly-plastic compressive response with plastic deformation initiating at an elastic strain of about 0.01. Beyond the elastic limit the stress-strain curve exhibits a slope implying the presence of significant work hardening. This behavior is not observed in bulk metallic glasses, which normally show strain-softening behavior beyond the elastic limit. These tests were conducted with the specimens unconfined, where monolithic amorphous metal would fail catastrophically. In these compression tests, failure occurred on a plane oriented at about 45° from the loading axis. This behavior is similar to the failure mode of the bulk metallic glass matrix. Plates made with faster cooling rates and smaller dendrite sizes have been shown to fail at about 20% strain when tested in tension.

One may also design good bulk glass-forming alloys with high titanium content as compared with the high zirconium content alloys described above. Thus, for example, in the Zr—Ti—M—Ni—Cu—Be alloy system a suitable glass-forming composition comprises (Zr₁₀₀₋ₓTi_{x-z}M_{z})_{100-y}((Ni₄₅CU₅₅))₅₀Be₅₀)_{y} where x is in the range of from 5 to 95, y is in the range of from 10 to 30, z is in the range of from 3 to 20, and M is selected from the group consisting of niobium, tantalum, tungsten, molybdenum, chromium and vanadium. Amounts of other elements or excesses of these elements may be added for partitioning from the melt to form a ductile second phase embedded in an amorphous matrix.

Experimental results indicate that the beta phase morphology and spacing may be controlled by chemical composition and/or processing conditions. This in turn may yield significant improvements in the properties observed; e.g., fracture toughness and high-cycle fatigue. These results offer a substantial improvement over the presently existing bulk metallic glass materials.

Earlier ductile metal-reinforced bulk metallic glass matrix composite materials have not shown large improvements in the Charpy numbers or large plastic strains to failure. This is due at least in part to the size and distribution of the secondary particles mechanically introduced into the bulk metallic glass matrix. The substantial improvements observed in the new in situ-formed composite materials are manifest by the dendritic morphology, particle size, particle spacing, periodicity and volumetric proportion of the ductile beta phase. This dendrite distribution leads to a confinement geometry that allows for the generation of a large shear band density, which in turn yields a large plastic strain within the material.

Another factor in the improved behavior is the quality of the interface between the ductile metal beta phase and the bulk metallic glass matrix. In the new composites this interface is chemically homogeneous, atomically sharp and free of any third phases. In other words, the materials on each side of the boundary are in chemical equilibrium due to formation of dendrites by chemical partitioning from a melt. This clean interface allows for an iso-strain boundary condition at the particle-matrix interface; this allows for stable deformation and for the propagation of shear bands through the beta phase particles.

Thus, it is desirable to form a composite in which the ductile metal phase included in the glassy matrix has a stress induced martensitic transformation. The stress level for transformation induced plasticity, either martensite transformation or twinning, of the ductile metal particles is at or below the shear strength of the amorphous metal phase.

The ductile particles preferably have face centered cubic (fcc), bcc or hexagonal close-packed (hcp) crystal structures, and in any of these crystal structures there are compositions that exhibit stress-induced plasticity, although not all fcc, bcc or hcp structures exhibit this phenomenon. Other crystal structures may be too brittle or transform to brittle structures that are not suitable for reinforcing an amorphous metal matrix composite.

This new concept of chemical partitioning is believed to be a global phenomenon in a number of bulk metallic glass-forming systems; i.e., in composites that contain a ductile metal phase within a bulk metallic glass matrix, that are formed by in situ processing. For example, similar improvements in mechanical behavior may be observed in (Zr₁₀₀₋ₓTi_{x-z}M_{z})₁₀₀₋ₓ(X)_{y} materials, where X is a combination of late transition metal elements that leads to the formation of a bulk metallic glass; in these alloys X does not include Be.

It is important that the crystalline phase be a ductile phase to support shear band deformation through the crystalline phase. If the second phase in the amorphous matrix is an intrinsically brittle ordered intermetallic compound or a Laves phase, for example, there is little ductility produced in the composite material. Ductile deformation of the particles is important for initiating and propagating shear bands. It may be noted that ductile materials in the particles may work harden, and such work hardening can be mitigated by annealing, although it is important not to exceed a glass transition temperature that would lose the amorphous phase.

The particle size of the dendrites of crystalline phase can also be controlled during the partitioning. If one cools slowly through the region between the liquidus and processing temperature, few nucleation sites occur in the melt and relatively larger particle sizes can be formed. On the other hand, if one cools rapidly from a completely molten state above the liquidus to a processing temperature and then holds at the processing temperature to reach near equilibrium, a larger number of nucleation sites may occur, resulting in smaller particle size.

The particle size and spacing between particles in the solid phase may be controlled by cooling rate between the liquidus and solidus, and/or time of holding at a processing temperature in this region. This may be a short interval to inhibit excessive crystalline growth. The addition of elements that are partitioned into the crystalline phase may also assist in controlling particle size of the crystalline phase. For example, addition of more niobium apparently creates additional nucleation sites and produces finer grain size. This can leave the volume fraction of the amorphous phase substantially unchanged and simply change the particle size and spacing. On the other hand, a change in temperature between the liquidus and solidus from which the alloy is quenched can control the volume fraction of crystalline and amorphous phases. A volume fraction of ductile crystalline phase of about 25% appears near optimum.

In one example, the solid phase formed from the melt may have a composition in the range of from 67 to 74 atomic percent zirconium, 15 to 17 atomic percent titanium, 1 to 3 atomic percent copper, 0 to 2 atomic percent nickel, and 8 to 12 atomic percent niobium. Such a composition is crystalline, and would not form an amorphous alloy at reasonable cooling rates.

The remaining liquid phase has a composition in the range of from 35 to 43 atomic percent zirconium, 9 to 12 atomic percent titanium, 7 to 11 atomic percent copper, 6 to 9 atomic percent nickel, 28 to 38 atomic percent beryllium, and 2 to 4 atomic percent niobium. Such a composition falls within a range that forms amorphous alloys upon sufficiently rapid cooling.

Upon cooling through the region between the liquidus and solidus at a rate estimated at less than 50 K/sec, ductile dendrites are formed with primary lengths of about 50 to 150 micrometers. (Cooling was from one face of a one centimeter thick body in a water cooled copper crucible.) The dendrites have well-developed secondary arms in the order of four to six micrometers wide, with the secondary arm spacing being about six to eight micrometers. It has been observed in compression tests of such material that shear bands are equally spaced at about seven micrometers. Thus, the shear band spacing is coherent with the secondary arm spacing of the dendrites.

In other castings with cooling rates significantly greater, probably at least 100 K/sec, the dendrites are appreciably smaller, about five micrometers along the principal direction and with secondary arms spaced about one to two micrometers apart. The dendrites have more of a snowflake-like appearance than the more usual tree-like appearance. Dendrites seem less uniformly distributed and occupy less of the total volume of the composite (about 20%) than in the more slowly cooled composite. (Cooling was from both faces of a body 3.3 mm thick.) In such a composite, the shear bands are more dense than in the composite with larger and more widely spaced dendrites. It is estimated that in the first composite about four to five percent of the volume is in shear bands, whereas in the “finer grained” composite the shear bands are from two to five times as dense. This means that there is a greater amount of deformed metal, and this is also shown by the higher strain to failure in the second composite.

As used herein, when speaking of particle size or particle spacing, the intent is to refer to the width and spacing of the secondary arms of the dendrites, when present. In absence of a dendritic structure, particle size would have its usual meaning, i.e., for round or nearly round particles, an average diameter. It is also possible that acicular or lamellar ductile metal structures may be formed in an amorphous matrix. Width of such structures is considered as particle size. It will also be noted that the secondary arms in a dendritic are not uniform width; they taper from a wider end adjacent the principal axis toward a pointed or slightly rounded free end. Thus, the “width” is some value between the ends in a region where shear bands propagate. Similarly, since the arms are wider at the base, the spacing between arms narrows at that end and widens toward the tips. Shear bands seem to propagate preferentially through regions where the width and spacing are about the same magnitude. The dendrites are, of course, three-dimensional structures and the shear bands are more or less planar, so this is only an approximation.

When referring to particle spacing, the center-to-center spacing is intended, even if the text may inadvertently refer to the spacing in a context that suggests edge-to-edge spacing.

One may also control particle size by providing artificial nucleation sites distributed in the melt. These may be minute ceramic particles of appropriate crystal structure or other materials insoluble in the melt. Agitation may also be employed to affect nucleation and dendrite growth. Cooling rate techniques are preferred since repeatable and readily controlled.

It appears that the improved mechanical properties can be obtained from such a composite material where the second ductile metal phase embedded in the amorphous metal matrix, has a particle size in the range of from about 0.1 to 15 micrometers. If the particles are smaller than 100 nanometers, shear bands may effectively avoid the particles and there is little if any effect on the mechanical properties. If the particles are too large, the ductile phase effectively predominates and the desirable properties of the amorphous matrix are diluted. Preferably, the particle size is in the range of from 0.5 to 8 micrometers since the best mechanical properties are obtained in that size range. The particles of crystalline phase should not be too small or they are smaller than the width of the shear bands and become relatively ineffective. Preferably, the particles are slightly larger than the shear band spacing.

The spacing between adjacent particles are preferably in the range of from 0.1 to 20 micrometers. Such spacing of a ductile metal reinforcement in the continuous amorphous matrix induces a uniform distribution of shear bands throughout a deformed volume of the composite, with strain rates in the range of from about 10⁻⁴ to 10³ per second. Preferably, the spacing between particles is in the range of from 1 to 10 micrometers for the best mechanical properties in the composite.

The volumetric proportion of the ductile metal particles in the amorphous matrix is also significant. The ductile particles are preferably in the range of from 5 to 50 volume percent of the composite, and most preferably in the range of from 15 to 35% for the best improvements in mechanical properties. When the proportion of ductile crystalline metal phase is low, the effects on properties are minimal and little improvement over the properties of the amorphous metal phase may be found. On the other hand, when the proportion of the second phase is large, its properties dominate and the valuable assets of the amorphous phase are unduly diminished.

There are circumstances, however, when the volumetric proportion of amorphous metal phase may be less than 50% and the matrix may become a discontinuous phase. Stress induced transformation of a large proportion of in situ-formed crystalline metal modulated by presence of a smaller proportion of amorphous metal may provide desirable mechanical properties in a composite.

The size of and spacing between the particles of ductile crystalline metal phase preferably produces a uniform distribution of shear bands having a width of the shear bands in the range of from about 100 to 500 nanometers. Typically, the shear bands involve at least about four volume percent of the composite material before the composite fails in strain. Small spacing is desirable between shear bands since ductility correlates to the volume of material within the shear bands. Thus, it is preferred that there be a spacing between shear bands when the material is strained to failure in the range of from about 1 to 10 micrometers. If the spacing between bands is less than about ½ micrometer or greater than about 20 micrometers, there is little toughening effect due to the particles. The spacing between bands is preferably about two to five times the width of the bands. Spacing of as much as 20 times the width of the shear bands can produce engineering materials with adequate ductility and toughness for many applications.

In one example, when the band density is about 4% of the volume of the material, the energy of deformation before failure is estimated to be in the order of 23 joules (with a strain rate of about 10² to 10³/sec in a Charpy-type test). Based on such estimates, if the shear band density were increased to 30 volume percent of the material, the energy of deformation rises to about 120 joules.

For alloys usable for making objects with dimensions larger than micrometers, cooling rates from the region between the liquidus and solidus of less than 1000 K/sec are desirable. Preferably, cooling rates to avoid crystallization of the glass-forming alloy are in the range of from 1 to 100 K/sec or lower. For identifying acceptable glass-forming alloys, the ability to form layers at least 1 millimeter thick has been selected. In other words, an object having an amorphous metal alloy matrix has a thickness of at least one millimeter in its smallest dimension.

Optionally, one or more additives can be used in an in situ composite of bulk-solidifying amorphous alloy. In preferred embodiments, at least 5 percent, preferably 75 percent, even more preferably 90 percent, even more preferably substantially all of the material in the fish hook according to the present invention is an in situ composite of bulk-solidifying amorphous alloy.

A fishing pliers according to the present invention can be made using methods known or yet to be discovered. Practical and cost-effective methods to produce fishing pliers made out of material including an in situ composite of bulk-solidifying amorphous alloy include metal mold casting methods, such as high-pressure die-casting, as these methods provide suitable cooling rates. Suitable methods to cast items are disclosed in, e.g., U.S. Pat. Nos. 5,213,148; 5,279,349; 5,711,363; 6,021,840; 6,044,893; and 6,258,183, and U.S. Pub. No. 2003/0075246. Optionally, casting a fishing pliers of the present invention can be carried out under an inert atmosphere or in a vacuum. Other methods, besides those listed herein, are also contemplated by the present invention.

Other embodiments of this invention will be apparent to those skilled in the art upon consideration of this specification or from practice of the invention disclosed herein. Various omissions, modifications, and changes to the principles and embodiments described herein may be made by one skilled in the art without departing from the true scope and spirit of the invention which is indicated by the following claims.

What is claimed is:

1. Pliers comprising a composite material comprising: individual regions of a ductile metal phase distributed in a substantially continuous amorphous metal alloy matrix.

2. The pliers of claim 1, wherein the ductile metal phase is formed in situ in the matrix by crystallization from a molten alloy.

3. The pliers of claim 1, wherein ductile metal phase comprises an alloy having an original composition of from about 50 to 80 atomic percent zirconium, about 2 to about 20 atomic percent titanium, about 2 to about 10 atomic percent copper, about 1 to about 9 atomic percent nickel, about 0 to about 15 atomic percent beryllium, and about 1 to about 25 atomic percent niobium.

4. The pliers of claim 1, wherein the regions of the ductile metal phase are sufficiently spaced apart for inducing a uniform distribution of shear bands throughout a deformed volume of the composite material.

5. The pliers of claim 4, wherein the shear bands involve at least four volume percent of the composite material before failure in strain and traverse both the amorphous metal alloy matrix and the ductile metal phase.

6. The pliers of claim 1, wherein the ductile phase is in the form of dendrites.

7. The pliers of claim 6, wherein the dendrites have primary lengths of about 15 to 150 micrometers, the dendrites comprise secondary arms having widths of about 4 to 6 micrometers, and the secondary arms are spaced apart about 6 to 8 micrometers.

8. The pliers of claim 1, wherein the ductile metal phase has an interface in chemical equilibrium with the amorphous metal alloy matrix.

9. The pliers of claim 1, wherein the ductile metal phase comprises particles.

10. The pliers of claim 9, wherein the particles are spaced apart from about 0.1 to about 20 micrometers.

11. The pliers of claim 9, wherein the particles have a particle size from 0.1 to 15 micrometers, spacing between adjacent particles from 0.1 to 20 micrometers, the particles are from about 5 to 50 volume percent of the composite material, the particles are sufficiently spaced apart for inducing a uniform distribution of shear bands traversing both the amorphous metal alloy matrix and the ductile metal phase and having a width of each shear band in the range of from 100 to 500 nanometers.

12. The pliers of claim 1, wherein the ductile phase comprises from 15 to 35 volume percent of the composite material.

13. The pliers of claim 1, wherein the composite material is free of a third phase.

14. The pliers of claim 1, wherein the composite material has a stress induced martensitic transformation.

15. The pliers of claim 1, wherein the amorphous metal alloy matrix comprises from about 35 to about 70 atomic percent zirconium plus titanium, from about 0 to about 35 atomic percent beryllium, and from about 5 to about 40 atomic percent total of copper plus nickel.

16. The pliers of claim 1, wherein the composite material is corrosion resistant.

17. The pliers of claim 1, wherein the composite material is wear-resistant.

18. Pliers comprising a first lever arm and a second lever arm that is complementary to the first lever arm, wherein the two arms are pivotally attached, and at least a portion of at least one of the two arms comprises a composite material comprising individual regions of a ductile metal phase distributed in a substantially continuous amorphous metal alloy matrix.

19. The pliers of claim 18, wherein the two arms are pivotally attached by a pivot point in an intermediate portion of each arm, and each arm includes a handle portion that extends proximally from the intermediate portion and a jaw portion that extends distally from the intermediate portion.

20. The pliers of claim 19, wherein the handle portions include at least one cut-out.

21. A method of forming pliers, comprising the steps of:
providing a composite material comprising individual regions of a ductile metal phase distributed in a substantially continuous amorphous metal alloy matrix; and
forming the composite into pliers.

22. The method of claim 21, wherein the ductile metal phase is formed in situ in the amorphous metal alloy matrix by crystallization from a molten alloy.

23. The method of claim 21, wherein the forming step is performed by a molding or a casting process.
